(19) United States
(12) Patent Application Publication
(10) Pub. No.: US 2016/0180050 A1
(43) Pub. Date: Jun. 23, 2016

(54) METHODS FOR DETERMINING HEALTH RISKS

(71) Applicant: TapGenes, Inc., Chicago, IL (US)

(72) Inventors: Heather Holmes, Chicago, IL (US); Emily Chang, Chicago, IL (US)

(21) Appl. No.: 14/925,454

(22) Filed: Oct. 28, 2015

Related U.S. Application Data
(60) Provisional application No. 62/195,072, filed on Jul. 21, 2015.
(60) Provisional application No. 62/069,573, filed on Oct. 28, 2014.

(51) Int. Cl. G06F 19/00

(52) U.S. Cl. CPC G06F 19/3431; G06F 19/323

(57) ABSTRACT

The present disclosure provides systems and methods for health management. The system can calculate a health risk of a subject based on health data and family health history. The system can calculate an age that corresponds to a subject's state of health based on health data. The system can provide a pictorial representation of the family health history of a subject. Based on the calculated age and health risks, the system can provide health recommendations customized for the subject.

### CROSS REFERENCE

This application claims the benefit of U.S. Provisional Patent Application No. 62/069,573, filed on Oct. 28, 2014, and U.S. Provisional Patent Application No. 62/195,072, filed on Jul. 21, 2015, each of which is incorporated herein by reference in its entirety.

### BACKGROUND OF THE INVENTION

A subject's health data, for example, family health history can provide valuable information about the subject's state of health and associated risk factors. However, obtaining meaningful information in a personalized subject-specific manner from the plethora of health data can be challenging. Current health management systems can provide limited information and can preclude an accurate assessment of a subject's overall state of health.

### SUMMARY OF THE INVENTION

In some embodiments, the invention provides for a method comprising: a) receiving an electronic communication containing health information encoded in a computer-readable code for each of a subject and a blood relative of the subject; b) extracting from the computer-readable code the encoded health information of the subject and transferring the extracted encoded health information of the subject to a first memory sector; c) extracting from the computer-readable code the encoded health information of the blood relative of the subject and transferring the extracted encoded health information of the blood relative of the subject to a second memory sector; d) creating a health profile of the subject by copying content of the first memory sector into the health profile of the subject; e) creating a health profile of the blood relative of the subject by copying content of the second memory sector into the health profile of the blood relative of the subject; f) displaying on a visual display the health profile of the subject and the health profile of the blood relative of the subject in a spatial relationship that suggests a genealogical relationship between the subject and the blood relative of the subject; g) generating a query based on the extracted encoded health information of the subject and the extracted encoded health information of the blood relative of the subject; h) searching a database based on the query, wherein the database stores entries, each entry encoded with health risks of a member of a sample population, to identify a health risk within the sample population common to a health risk present in the extracted encoded health information of the subject; i) searching the database based on the query, wherein the database stores entries, each entry encoded with health risks of a member of the sample population, to identify a health risk within the sample population common to a health risk present in the extracted encoded health information of the blood relative of the subject; f) computing a relative level of risk for the subject versus the sample population based on a comparison; and g) electronically annotating the health profile of the subject with the computed relative level of risk for the subject versus the sample population.

In some embodiments, the invention provides a method comprising: a) creating on a physical memory a first data node and a second data node; b) creating on the physical memory a first subnode associated with the first data node; c) creating on the physical memory a second subnode associated with the second data node; d) populating the first data node with a computer-readable code that encodes an image of a person; e) populating the second data node with a computer-readable code that encodes an image of a relative of the person; f) populating the first subnode with health risk data of the person; g) populating the second subnode with health episode data of the relative of the person; h) transmitting from the first data node to a visual display module an electronic signal that conveys the computer-readable code that encodes the image of the person; i) transmitting from the second data node to the visual display module an electronic signal that conveys the computer-readable code that encodes the image of the relative of the person; j) processing by the visual display module the computer-readable code that encodes the image of the person into an image of the person; k) processing by the visual display module the computer-readable code that encodes the image of the relative of the person into an image of the relative of the person; l) displaying on a visual display the image of the person and the image of the relative of the person in a spatial relationship that suggests a genealogical relationship between the person and the relative of the person; m) transmitting from the first subnode to a health icon module an electronic signal that conveys the health risk data of the person; n) transmitting from the second subnode to the health icon module an electronic signal that conveys the health episode data of the relative of the person; o) processing by the health icon module the health risk data of the person to produce an icon that suggests a health risk of the person; p) processing by the health icon module the health episode data of the relative of the person to produce an icon that identifies a health episode of the relative of the person; q) displaying on the visual display module in proximity to the image of the person the icon that suggests the health risk of the person; and r) displaying on the visual display module in proximity to the image of the relative of the person the icon that identifies the health episode of the relative of the person.

In some embodiments, the invention provides for a method comprising: a) receiving an electronic communication comprising health information of a subject encoded in a computer-readable code; b) extracting from the computer-readable code the encoded health information of the subject and transferring the extracted encoded health information of the subject to a memory sector; c) creating a health profile of the subject by copying content of the memory sector into the health profile; d) identifying a plurality of health risk factors of the subject based on the health profile of the subject; e) generating a query based on the identified health risk factors of the subject; f) searching a database based on the query, wherein the database stores entries of a sample population, wherein each entry is encoded with an age and a health risk of a member of the sample population, to identify an age adjustment factor that corresponds to one of the identified health risk factors of the subject; g) calculating an age of the subject based on a plurality of age adjustment factors; and h) electronically annotating the health profile of the subject with the calculated age of the subject, wherein the calculated age corresponds to the subject's state of health based on the extracted health data of the subject.

### BRIEF DESCRIPTION OF THE FIGURES

FIG. 1 illustrates logistical approximation of age and gender-specific incidence data for colon cancer.

FIG. 2 illustrates approximation of age-specific incidence data for prostate cancer.

FIG. 3 illustrates ages calculated by a system of the invention for women with and without a family history of skin cancer.

FIG. 4 illustrates the probability of developing a health condition plotted against age.

FIG. 5 illustrates ages calculated by a system of the invention for women with and without a family history of breast cancer before capping the maximum and minimum calculated ages.

FIG. 6 illustrates ages calculated by a system of the invention for women with and without a family history of breast cancer after capping the maximum and minimum calculated ages.

FIG. 7 is a block diagram illustrating a first example architecture of a computer system that can be used in connection with example embodiments of the present invention.

FIG. 8 is a diagram illustrating a computer network that can be used in connection with example embodiments of the present invention.

FIG. 9 is a block diagram illustrating a second example architecture of a computer system that can be used in connection with example embodiments of the present invention.

FIG. 10 illustrates a global network that can transmit a product of the invention.

FIG. 11 illustrates a family health tree displayed by a system of the invention.

FIG. 12 illustrates steps for constructing a health risk model.

FIG. 13 illustrates a health risk determined by a system of the invention.

### DETAILED DESCRIPTION

A subject's health and likelihood of developing a health condition can be influenced by numerous factors. These factors can include, for example, genetic factors, lifestyle factors, environmental factors, or any combination thereof. Furthermore, the likelihood of developing a health condition can vary from one subject to another and can be specific to each subject.

The present disclosure provides systems and methods for health management. The systems and methods can be used to calculate an age that corresponds to the subject's state of health based on, for example, the subject's health data and health data of one or more blood relatives of the subject. The system can determine health risks of a subject associated with one or more health conditions. Information relating to age and health risks provided by the system can be used, for example, to take preventative actions, diagnose health conditions, correlate a subject's symptoms to a health condition, recognize potential allergies, and choose more effective treatments, medications, therapies, and procedures suited to the specific health data of the subject. Methods and systems of the invention can provide health recommendations customized for the subject, for example, the system can recommend lifestyle changes based on health data of the subject, such as a genetic predisposition to a health condition. The system can provide a pictorial representation of the health data and health risks of the subject and the subject's relatives, for example, a family health tree. Based on the system's output of, for example, health risks, calculated age, and health recommendations, a therapeutic intervention can be carried out.

Collection of data from a population of subjects can provide information useful for finding variables highly-associated with a disease or health condition. The variables can be, for example, age, gender, lifestyle, and family history. Variables determined to be associated with a health condition can be used to create, for example, highly-accurate disease-specific or health-condition specific models. Population health data can be used by a system of the invention, for example, to predict age of death of a subject based on age of death of a subject's relatives, for example, grandparents; to determine relative risks useful for refining or adjusting a subject's age calculation based on health data; ranking subjects in a database based on how healthy subjects' lifestyle choices are, and how subjects' family histories compare to those of other subjects in the database or population; and recommending a genetic test based on family history information. Methods of the invention can be used for therapeutic intervention in a subject.

### Methods of the Invention.

### Health Data

A system of the invention can collect health data about a subject. Health data can include, for example, age, date of birth, gender, weight, height, waist size, body mass index, race, family health history, family medical history, personal medical history, medication use, multivitamin use, allergies, past surgeries, procedures, genetic data, clinical data, weight gain in a defined period of time, birth weight, number of pregnancies, age of menarche, age at the time of pregnancy, breastfeeding, personal history of a health condition, age of menopause, postmenopausal, contraceptive use, hormone use, drug use, number and frequency of alcohol intake, smoking, physical activity, diet, screening for health conditions, blood pressure, vital signs, blood type, skin color, eye color, hair color, body mass index (BMI), and exercise habits.

In some embodiments, health data comprises data about environmental factors associated with a health condition. Non-limiting examples of environmental factors include exposure to chemicals, asbestos, rubber, aluminum, aromatic amines, radiation, sun, disease vectors, second-hand smoking, air pollution, impure water, and mold.

In some embodiments, health data comprises genetic data. Genetic data can be obtained by, for example, sequencing a biological sample of a subject. Genetic data can be obtained from, for example, genetic databases, DNA banking facilities, and gene repositories. Any suitable method for sequencing, for example, next generation sequencing, can be used to obtain the genetic data of the subject.

Genetic data of a subject or a population can take many forms. Non-limiting examples of genetic data include a gene, a genotype, an allele, a mutation, a polymorphism, a result of a restriction fragment length polymorphism test (RFLP), a result of a polymerase chain reaction test (PCR), a result of a paternity test, a nucleic acid sequence, the expression, penetrance, prevalence, copy number, pathway, function, or chromosomal location of any of the foregoing, and combinations thereof.

In some embodiments, health data comprises data about family health history. Data about family history can include health information from any suitable blood relative of the subject, for example, first-degree relatives, second-degree relatives, and third-degree relatives. First-degree relatives can include, for example, parents, siblings, and offspring. Second-degree relatives can include, for example, nieces, nephews, half-siblings, grandparents, grandchildren, aunts, and uncles. Third-degree relatives can include, for example, first-cousins, great-grandparents, and great grandchildren. Family history can include health data from stepchildren, stepparents, and half-siblings. Family history can include health data from an individual genetically-related to the subject. The system can be customized to choose the relatives to be included in the family health history.

In some embodiments, the family history comprises health information from one or more first-degree relatives. In some embodiments, the family history comprises health information from one or more first-degree blood relatives and one or more second-degree blood relatives of the subject. In some embodiments, the family history comprises health information from a blood relative of the subject. In some embodiments, the family history comprises health information from more than one blood relative of the subject.

A system of the invention can collect and store health episode data of a subject or a relative of the subject. In some embodiments, the system collects health episode data of a relative of the subject. In some embodiments, the system uses a health episode data of a relative of the subject to calculate, for example, health risk, and age of a subject. Non-limiting examples of health episode include anemia, angina, anxiety, arrhythmia, allergies, benign prostatic hyperplasia, cold agglutinin disease, cancer, cataract, clostridium difficile, chronic heart failure, constipation, chronic obstructive pulmonary disease, cerebrovascular accident, dementia, depression, dyslipidemia, diabetes mellitus, deep vein thrombosis, gastroesophageal reflux disease, gastrointestinal bleeding, glaucoma, hypertension, hypothyroid, intubation, myocardial infarction, pulmonary embolism, pneumonia, psychiatric history, peptic ulcer disease, peripheral vascular disease, osteoarthritis, obesity, osteoporosis, rheumatoid arthritis, renal insufficiency, seizure, urinary incontinence, surgical history, family availability, mobility, independence, substance use, for example, alcohol, tobacco, and prescription and non-prescription drugs. Health episode data can include symptoms associated with a health episode, for example, a) constitution abnormalities, including, for example, fever, change in mental status, change in function, change in health status, change in weight, and pain; b) gastrointestinal abnormalities, including, for example, nausea, vomiting, obesity, abdominal pain, diarrhea, constipation, melena, heme-occult, dysphagia, dyspepsia, change in appetite, and change in stool; c) neurological abnormalities, including, for example, syncope, aphasia, head ache, vertigo, focal weakness, paresthesia, seizures, change in speech, change in sensory perceptions, and change in temperature perceptions; d) musculoskeletal abnormalities, including, for example, joint pain, swelling, myalgia, arthralgia, change in range of motion, risk of falls, history of falls, and gait disorder; e) respiratory abnormalities, including, for example, shortness of breath, cough, wheezing, change in sputum amount, change in sputum color, and change in sputum tenacity; f) head-eyes-ears-nose-and-throat (HEENT) abnormalities, including, for example, visual changes, hearing changes, vision aids, tinnitus, dental pain, and dentures; g) genitourinary abnormalities, including, for example, dysuria, hematuria, change in frequency, urgency, nocturia, change in continence, and change in hydration; h) psychiatric abnormalities, including, for example, anxiety, depression, sleep disturbance, combativeness, psychosis, hallucinations, delusions, and substance abuse; i) cardiovascular/pulmonary-vascular abnormalities, including, for example, chest pain, palpitations, dizziness, dyspnea on exertion, and edema; and j) dermatological abnormalities, including, for example, rash, pruritus, bruising, and open areas. In some embodiments, the health episode data comprises a cardiovascular episode. In some embodiments, the health episode data comprises cancer. In some embodiments, the health episode data comprises diabetes. In some embodiments, the health episode data comprises a lung condition, for example, allergy, and asthma. In some embodiments, the health episode data comprises a metabolic condition, for example, diabetes. In some embodiments, the health episode data comprises a brain or neurological condition. In some embodiments, the health episode data comprises stroke.

A system of the invention can generate a health profile of a subject, for example, a personal health portrait, based on the health data. The health data used by the system to generate a health profile and calculate age of a subject can be customized for each subject based on, for example, the health condition, age, and gender of the subject. For example, health data used by the system for prostate cancer can include, for example, gender, height, calcium intake, fat intake, family history, and race.

A subject's health profile or health data can be compared to a database of health data from a plurality of subjects. The comparison with the database of health data can be used to calculate a health risk of the subject. The database can comprise any suitable health data of the plurality of subjects to be compared with the health data of the subject, for example, age, gender, race, and health risks of each of the plurality of subjects.

### Pictorial Representation

In some embodiments, a system of the invention provides a pictorial representation of a family health tree of a subject. In some embodiments, the system comprises a computer system having a display device, a processor device, a database, a node, a subnode, a memory sector, and media having computer-executable instructions configured to display genealogical relationship and health data of related individuals according to a method described herein. The system can comprise, for example, computer-readable media, physical memory, physical drives, visual display modules, icon modules, icons, memory sectors, and data files.

The system can receive electronic communication comprising, for example, health information, encoded in a computer readable form. The system can extract from the computer-readable code the encoded information. The system can transfer the extracted information to, for example, memory sectors, physical memory, nodes, and subnodes.

A system can comprise a communications interface operatively coupled to a user terminal and a healthcare provider terminal. The communications interface can be adapted to collect information from the user terminal, the healthcare provider terminal, or a combination thereof. The information collected can comprise, for example, information related to the health condition of the user, information about a medication administered to the user, and information about a physical condition of the user. The system can further comprise a data storage medium operatively coupled to the communications interface, and adapted to store the user information. The data storage medium can be coupled to a computer processor.

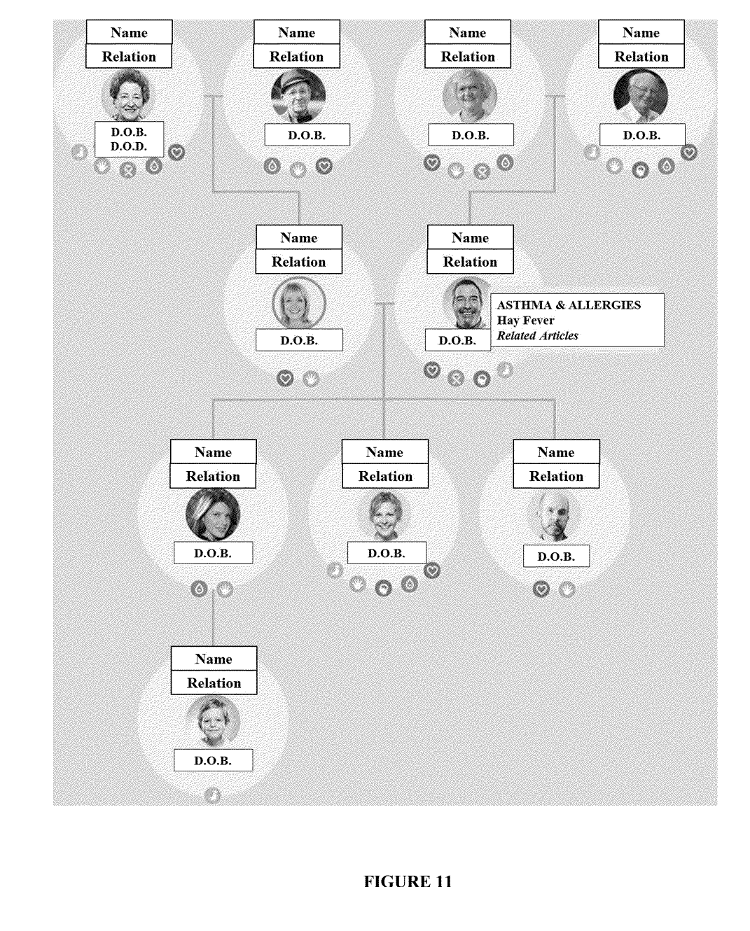

A system of the invention can collect and store an image of a subject. The system can collect and store an image of one or more blood relatives of the subject. The pictures can be displayed by the system in a manner that shows or suggests a genealogical relationship between the subject and the subject's family, for example, a family health tree (FIG. 11).

The system can be configured to assign specific icons for a health condition or health episode (FIG. 11). The icon can be displayed in proximity to an individual's image, indicating the health episode or health condition of the individual associated with the image.

The system can display an age of the subject calculated as described herein based on the health data next to an image of the subject. The system can display a health risk of the subject next to an image of the subject. The system can display a medication and vital signs next to an image of an individual.

### Health Risk

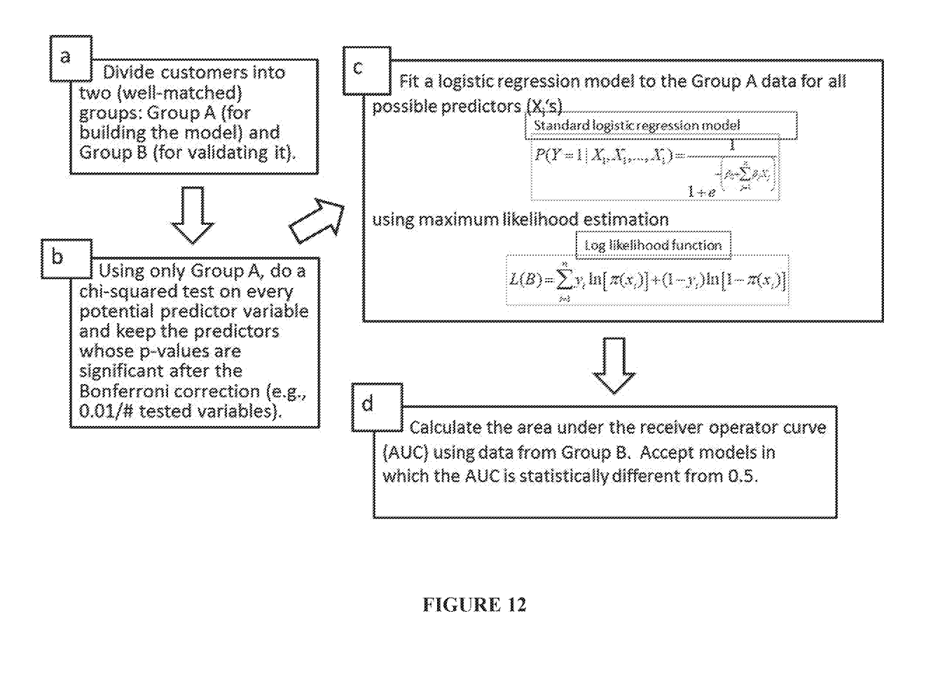

A system of the invention can determine a health risk of a subject based on, for example, health data of the subject and family health history. The system can collect health and family data from a population and save to a database. Based on the population data, the system can determine strongly associated predictors for each health condition. Based on the predictors, the system can construct a risk model, for example, as shown in FIG. 12. Using the risk model, personalized risk scores can be calculated for each subject based on the predictors.

A health risk of a subject can be adjusted based on family health history of the subject. For example, a subject with a family history of Type 2 diabetes can have two-times higher risk of developing Type 2 diabetes compared with a subject with no family history of Type 2 diabetes.

The health risk determined by the system can be qualitative, quantitative, or not quantitative. In some embodiments, the health risk determined by the system is not quantitative. In some embodiments, the health risk determined by the system is quantitative. The health risk can be adjusted based on, for example, the age, gender, and race of a subject.

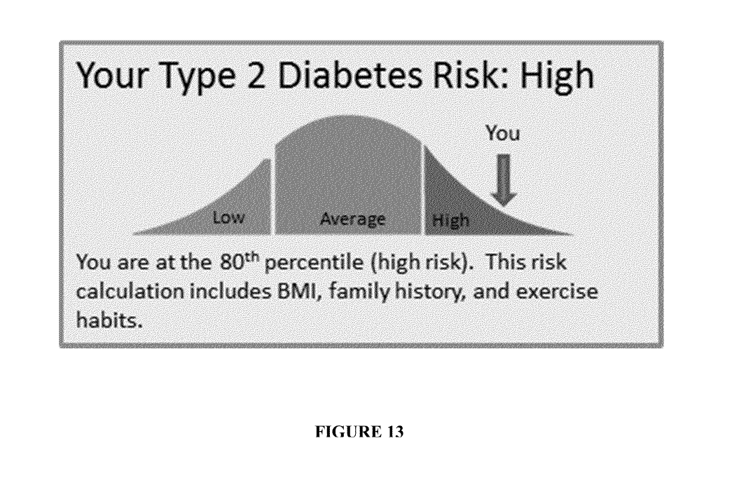

A health risk of a subject can indicate, for example, a risk of developing a health condition by the subject. The health risk can be reported in any suitable format. The health risk can be reported as high, average, or low. The health risk can be reported as a percentile of a population. The health risk can be reported as a bell curve. For example, as shown in FIG. 13, the health risk of developing a condition, for example, Type 2 diabetes can be high since the subject is in the 80^{th} percentile.

A health risk can be about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 45%, about 50%, about 55%, about 60%, about 65%, about 70%, about 75%, about 80%, about 85%, about 90%, about 95%, or about 100%.

### Genetic Age

A system of the invention can calculate the age of a subject based on the subject's relative risk associated with, for example, a family history of a health condition. The relative risk can indicate the subject's risk of developing the health condition. The relative risk associated with different health conditions can be the same or different depending on the health data associated with the health conditions. Relative risk associated with a health condition can be expressed in an age-dependent manner or as an average over all ages. In some embodiments, a positive family history of a health condition, for example, breast cancer, has a greater effect on relative risk in a younger population than on the relative risk in an older population. Relative risk associated with a health condition can be expressed in a gender-dependent manner or as an average of both genders. Relative risk can be calculated by the system using health data collected by the system. Relative risk can be obtained from a database, for example, the Disease Risk Index or Your Disease Risk.

The value of relative risk associated with a health condition can be for example, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.5, about 6, about 6.5, about 7, about 7.5, or about 8.

A system of the invention can use data associated with a prevalence of a health condition in a population. For each health condition, the system can determine and use the fraction of the population with, for example, a positive family history of a health condition. In some embodiments, prevalence data for a health condition corresponds to the fraction of a population with at least one family member with an affected first degree relative. Prevalence data associated with a positive family history can be based on, for example, 1, 2, 3, 4, 5, 6, 7, 8, 9, 10, or more family members with the health condition. The prevalence data can be reported in a gender-dependent manner or as an average of both genders. The prevalence data can be reported in an age-dependent manner or as an average over all ages. The prevalence data can be reported based on family size or as an average over all family sizes. In some embodiments, prevalence data corresponding to positive family history of a health condition in a population is reported as an average of all ages and family sizes. Prevalence of a health condition in a population can increase with an aging population. Prevalence can increase with large family sizes. The prevalence data can be reported, for example, as a percentage, ratio, fraction, or a probability. Prevalence of a health condition in a population can be, for example, about 0%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 45%, about 50%, about 55%, about 60%, about 65%, about 70%, about 75%, about 80%, about 85%, about 90%, about 95%, or about 100%. Prevalence data for a health condition can be obtained from a database, for example, Disease Risk Index or Your Disease Risk. In some embodiments, prevalence data is based on the population of the United States.

A system of the invention can determine P(Disease|Family History) and P(Disease|!Family History) in terms of P(Disease), population of disease in the general population using the equation:

$$RR = \frac{P ( D \vert E )}{P ( D \vert ! E )}$$

$$P ( D ) = P ( D \vert E ) * P ( E ) + P ( D \vert ! E ) * P ( ! E )$$

where RR is relative risk, E is exposure or family history, and D is disease. Since values for RR and P(E) and P(!E) can be determined based on relative risk values and prevalence data, the above equation can be solved for P(D|E) in terms of P(D), and P(D|!E) in terms of P(D) as follows:

$$P ( D \vert E ) = \frac{RR}{P ( E ) * RR + P ( ! E )} * P ( D )$$

An approximation of P(disease) as a function of age can be determined using age-specific crude incidence data for each health condition and each gender. The incidence data can be obtained from a database. For example, the National Cancer Institute's Surveillance, Epidemiology, and End Results (SEER) Program database can be used for obtaining cancer incidence data. Risk curves can be plotted using the incidence data and approximated with a logistic function using the middle age of each interval of the incidence data.

An example of age- and gender-specific crude incidence data obtained from the SEER database for bladder cancer is shown in Table 1:

TABLE 1

| Age at | | |
|---|---|---|
| Diagnosis | Males | Females |
| <1 | — | — |
| 1-4 | — | — |
| 5-9 | — | — |
| 10-14 | — | — |
| 15-19 | 0.4 | 0.3 |
| 20-24 | 1.1 | 0.8 |
| 25-29 | 2.2 | 2.2 |
| 30-34 | 4.9 | 4.3 |
| 35-39 | 8.8 | 8.6 |
| 40-44 | 17.8 | 16.4 |
| 45-49 | 33.3 | 27.9 |
| 50-54 | 64 | 51 |
| 55-59 | 84.6 | 59.9 |
| 60-64 | 120.3 | 80.5 |
| 65-69 | 174.8 | 118.6 |
| 70-74 | 233.5 | 162.5 |
| 75-79 | 279.4 | 213 |
| 80-84 | 333.7 | 261.4 |
| 85+ | 371 | 303.5 |

where “-” refers to low risk of bladder cancer.

In Table 1, the low risk of bladder cancer can be approximated as zero for age calculation by the system. Risk can be assumed to be linear within a given age range. Mean age can be used as the representative age for each age range.

A logistic curve of best fit can be constructed for the incidence data by minimizing the square of the differences between the predicted and actual risks. Parameters A, B, C, and D can be determined from the logistical equation:

$$P ( Disease ) = D + \frac{A - D}{1 + {( \frac{age}{C} )}^{B}}$$

where A is risk at youngest age, B is power, C is center of ages, and D is risk at oldest age.

For a number of health conditions, approximation of incidence data can be sigmoidal in shape and the logistical equation can be used. Approximation of the sigmoidal curve can provide an increasing function, without branching, and can be valid for most age ranges.

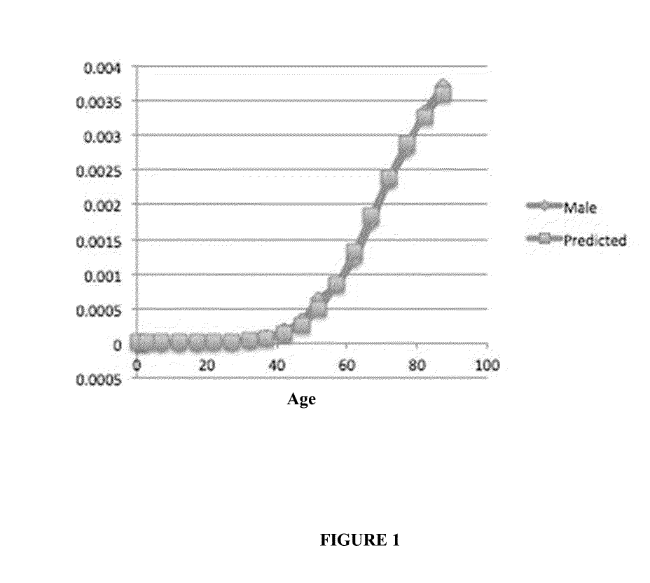

FIG. 1 illustrates a logistical approximation of age and gender-specific incidence data for colon cancer. As shown in FIG. 1, risk curves of predicted and observed risks were almost identical, indicating that data for colon cancer follows a good fit for logistical approximation.

For some health conditions, the P(disease) can decrease, for example, with age. The reduction in P(disease) with age can occur due to correlation with other health conditions, for example, an old age subject dying from a correlated health condition, for example, prostate cancer, or a lack of later life testing for the same.

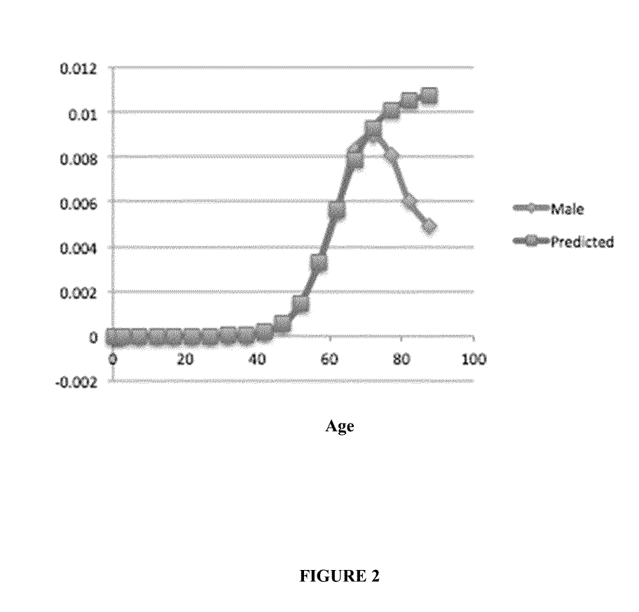

FIG. 2 illustrates approximation of age and gender-specific incidence data for prostate cancer. As shown in FIG. 2, the logistical approximation did not fit well for ages 70 and higher. Lack of screening for prostate cancer and decrease in observed prostate cancer cases for men aged 70 and higher can result in the reduced logistical approximation for older aged men.

For every age, the p(disease|E) and P(disease|!E) can be calculated using the equation:

$$P ( disease \vert E , {age}_{biological} ) = \frac{RR}{P ( E ) * RR + P ( ! E )} * ( D + \frac{A - D}{1 + {( \frac{{age}_{bilogical}}{C} )}^{B}} )$$

$$P ( disease \vert ! E , {age}_{biological} ) = \frac{1}{P ( E ) * RR + P ( ! E )} * ( D + \frac{A - D}{1 + {( \frac{{age}_{bilogical}}{C} )}^{B}} )$$

where RR is relative risk, E is exposure or family history, A is risk at youngest age, B is power, C is center of ages, and D is risk at oldest age.

For p(disease|E) and p(disease|!E), a corresponding age in the general population can be calculated using the equation:

$${age}_{genetic , family history} = C * {( \frac{A - D}{P ( disease \vert E , {age}_{biological} ) - D} - 1 )}^{1 / B}$$

$${age}_{genetic , no family history} = C * {( \frac{A - D}{P ( disease \vert ! E , {age}_{biological} ) - D} - 1 )}^{1 / B}$$

where RR is relative risk, E is exposure or family history, A is risk at youngest age, B is power, C is center of ages, and D is risk at oldest age.

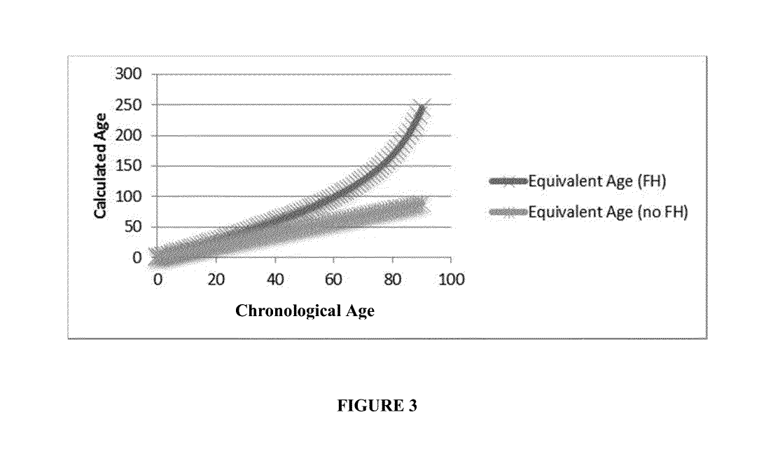

FIG. 3 illustrates ages calculated by a system of the invention for women with and without a family history of skin cancer. The X-axis represents the chronological age of the women, and the Y-axis represents the age that corresponds to the state of health of the women calculated based on health data of the women, for example, a family history of skin cancer.

A high risk of developing a health condition based on, for example, a positive family history of the health condition, can result in a calculated age of a subject that is greater than a chronological age seen in a general population, for example, a calculated age greater than 100 years. Conversely, a low risk of developing a health condition based on, for example, no family history of the health condition, can result in a calculated age of a subject that is lower than a chronological age seen in a general population, for example, a calculated age less than 0 years.

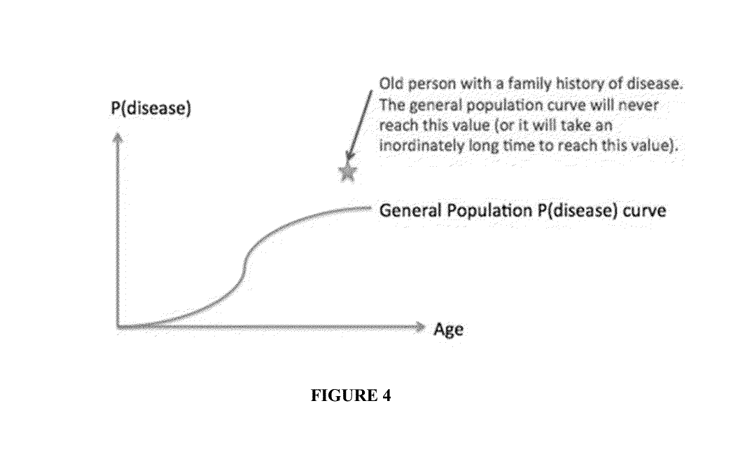

FIG. 4 illustrates the probability of a disease, P(disease), plotted against age. As shown, an old-aged subject with a family history of a disease can have a disease risk that is greater than that seen for a similarly-aged subject in a general population. The age calculated by the system can be capped within any suitable desired range, for example, highest calculated age can be capped at 100 years and lowest calculated age can be capped at 0 years.

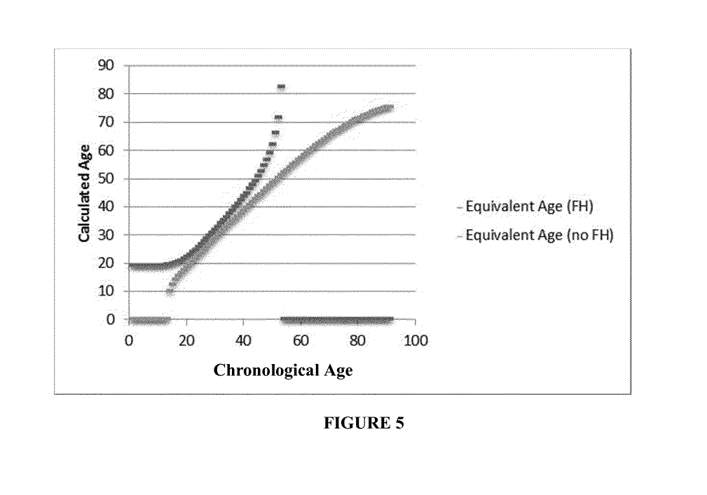

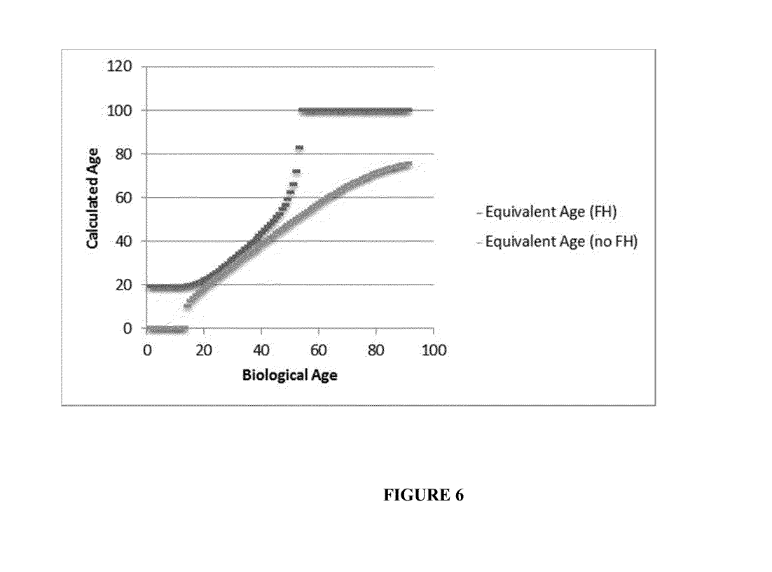

FIG. 5 illustrates ages calculated by a system of the invention for women with and without a family history of breast cancer before capping the maximum and minimum calculated ages. FIG. 6 illustrates ages calculated by a system of the invention for women with and without a family history of breast cancer after capping the maximum and minimum calculated ages. The infinitely-high and infinitely-low ages calculated by the system based on health data are plotted as zero in FIGS. 5 and 6. The risk of a subject from a general population can equal the risk of an elderly person with a family history of disease. In some embodiments, a subject with a calculated disease risk and age equivalent to a 100-year-old subject can be considered to be at a very high risk of developing a health condition. In some embodiments, a subject with a calculated disease risk and age equivalent to a 0-year-old subject can be considered to be at a very low risk of developing a health condition.

A system of the invention can calculate a health condition-specific age of a subject. For example, based on a subject's family history of health conditions, such as heart disease, diabetes, and cancer, the system can calculate ages of the subject associated with each health condition, namely, subject's age associated with heart disease, subject's age associated with diabetes, and subject's age associated with cancer. The health condition-specific age of the system can be based on health data associated with the health condition. The system can calculate, for example, 1, 2, 3, 4, 5, 6, 7, 8, 9, 10, 11, 12, 13, 14, 15, 16, 17, 18, 19, 20, or more health condition-specific ages of the subject.

A system of the invention can calculate an adjustment factor based on health condition-specific age of the subject. An adjustment factor can be based on, for example, 1, 2, 3, 4, 5, 6, 7, 8, 9, 10, 11, 12, 13, 14, 15, 16, 17, 18, 19, 20, or more health condition-specific ages of the subject. The adjustment factor can be used to adjust the chronological age of the subject to output an age of the subject, which corresponds to a state of health of the subject. The adjustment factor can be, for example, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.5, about 6, about 6.5, about 7, about 7.5, about 8, about 8.5, about 9, about 9.5, or about 10. The adjustment factor can be a positive value or a negative value. An age of a subject can be calculated based on the adjustment factors, for example, by arithmetically summing or adding the adjustment factors.

A weighting factor can be applied by a system of the invention, for example, a weighting factor can be applied to an adjustment factor or health condition-specific age of a subject. The weighting factor or weight can be, for example, about 0.001, about 0.002, about 0.003, about 0.004, about 0.005, about 0.006, about 0.007, about 0.008, about 0.009, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.5, about 6, about 6.5, about 7, about 7.5, about 8, about 8.5, about 9, about 9.5, or about 10. The weight factor can be a positive value or a negative value.

A system of the invention can calculate an overall age of the subject by arithmetically summing two or more health condition-specific ages of the subject. The overall age calculated by the system can suggest an increased or decreased likelihood of developing a health condition with a non-zero risk. The system can determine or assign weights to each health condition-specific age. The weights used for each health condition-specific age can be based on, for example, the prevalence of the health condition in a general population. A weighted average of each health condition-specific age can be summed by the system into the single overall calculated age. The system can sum, for example, 1, 2, 3, 4, 5, 6, 7, 8, 9, 10, 11, 12, 13, 14, 15, 16, 17, 18, 19, 20 or more health condition-specific ages to calculate the overall age of a subject. The health condition-specific ages to be summed by the system in calculating the overall age can be based on the gender of the subject, for example, ovarian cancer and breast cancer for females, and prostate cancer for males. Non-limiting examples of the health condition-specific ages considered by the system are heart disease, stroke, diabetes, bladder cancer, colon cancer, kidney cancer, lung cancer, pancreatic cancer, breast cancer, ovarian cancer, prostate cancer, skin melanoma, and ages associated with any risk factor or condition described herein.

An age of the subject calculated by a system of the invention can be compared with, for example, the chronological age of the subject. The calculated age of the subject can be compared with, for example, the biological age of the subject.

### Applications of a System of the Invention.

A system of the invention can be used to collect and store all health information together, for example, to keep health records for every member of a family; see conditions, medications, and copies of medical documents at a glance; and access records from anywhere including when traveling or during emergencies.

A system of the invention can be used to prepare for emergencies. Emergency profiles can be generated for each family member based on health information. Emergency access codes can be generated to share information with a health care provider.

A system of the invention can be used to share information, for example, among family members, caregivers, and healthcare providers. The information provided by a system of the invention can be used by, for example, a caregiver or a healthcare provider to make better and more informed decisions about the health of the subject, for example, prescribing medications.

A system of the invention can provide personalized health, medical, and educational content that is tailored to a subject or family's health needs.

A system of the invention can be used to calculate the age of a subject based on health data. The subject's age calculated by the system can be, for example, about 0, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, about 100, or more years.

A system of the invention can be used to determine the arithmetic difference between a calculated age of a subject based on health data and the subject's chronological age. The arithmetic difference can be a positive value or a negative value. The arithmetic difference can be about 0, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, about 100, or more years. The arithmetic difference can be about −1, about −2, about −3, about −4, about −5, about −6, about −7, about −8, about −9, about −10, about −11, about −12, about −13, about −14, about −15, about −16, about −17, about −18, about −19, about −20, about −21, about −22, about −23, about −24, about −25, about −26, about −27, about −28, about −29, about −30, about −31, about −32, about −33, about −34, about −35, about −36, about −37, about −38, about −39, about −40, about −41, about −42, about −43, about −44, about −45, about −46, about −47, about −48, about −49, about −50, about −51, about −52, about −53, about −54, about −55, about −56, about −57, about −58, about −59, about −60, about −61, about −62, about −63, about −64, about −65, about −66, about −67, about −68, about −69, about −70, about −71, about −72, about −73, about −74, about −75, about −76, about −77, about −78, about −79, about −80, about −81, about −82, about −83, about −84, about −85, about −86, about −87, about −88, about −89, about −90, about −91, about −92, about −93, about −94, about −95, about −96, about −97, about −98, about −99, about −100, or less years.

A subject can be, for example, an elderly adult, an adult, an adolescent, a child, a toddler, or an infant. A subject can be a male or a female. A subject can be a patient. A subject can be an individual or a customer.

A system of the invention can be used by a subject, patient, caregiver, family members of a subject, legal guardians of a subject, insurance providers, schools, universities, screening agencies, certification agencies, hospitals, clinics, pharmacists, and healthcare professionals. Non-limiting examples of healthcare professionals include physicians, nurses, therapists, paramedics, medical specialists, physician assistants, medical technicians, surgeons, surgeon's assistants, surgical technologists, clinical officers, physical therapists, occupational therapists, emergency medical technicians, and clinicians. A system of the invention can support any number of users. Each user can create a user profile, and edit the profile at any time.

Systems of the invention can be used in a hospital or research setting. In some embodiments, the invention is used outside a hospital or research setting. In some embodiments, the invention is used in a subject's home, and can allow communication between a hospital and a subject's home. Non-limiting examples of sites where systems of the invention can be used include a hospital, a satellite clinical and care management facility; a nursing facility; a hospice and palliative care facility; a clinic; an ambulatory surgery center; a temporary emergency off-site facility; a laboratory; a clinical trial site; a government institution; and a correctional facility.

A system of the invention can be applied to any health condition. Non-limiting examples of health conditions include cancer, cutaneous conditions, endocrine disorders, eye disorders, intestinal diseases, infectious diseases, genetic disorders, heart disease, stroke, diabetes, cancer, neurological disorders, Alzheimer's disease, dementia, arthritis, asthma, blood clots, depression, high cholesterol, high blood pressure, pregnancy loss, and birth defects.

Non-limiting examples of cancers include acute lymphoblastic leukemia, acute myeloid leukemia, adrenocortical carcinoma, AIDS-related cancers, AIDS-related lymphoma, anal cancer, appendix cancer, astrocytomas, basal cell carcinoma, bile duct cancer, bladder cancer, bone cancers, brain tumors, such as cerebellar astrocytoma, cerebral astrocytoma/malignant glioma, ependymoma, medulloblastoma, supratentorial primitive neuroectodermal tumors, visual pathway and hypothalamic glioma, breast cancer, bronchial adenomas, Burkitt lymphoma, carcinoma of unknown primary origin, central nervous system lymphoma, cerebellar astrocytoma, cervical cancer, childhood cancers, chronic lymphocytic leukemia, chronic myelogenous leukemia, chronic myeloproliferative disorders, colon cancer, cutaneous T-cell lymphoma, desmoplastic small round cell tumor, endometrial cancer, ependymoma, esophageal cancer, Ewing's sarcoma, germ cell tumors, gallbladder cancer, gastric cancer, gastrointestinal carcinoid tumor, gastrointestinal stromal tumor, gliomas, hairy cell leukemia, head and neck cancer, heart cancer, hepatocellular (liver) cancer, Hodgkin lymphoma, Hypopharyngeal cancer, intraocular melanoma, islet cell carcinoma, Kaposi sarcoma, kidney cancer, laryngeal cancer, lip and oral cavity cancer, liposarcoma, liver cancer, lung cancers, such as non-small cell and small cell lung cancer, lymphomas, leukemias, macroglobulinemia, malignant fibrous histiocytoma of bone/osteosarcoma, medulloblastoma, melanomas, mesothelioma, metastatic squamous neck cancer with occult primary, mouth cancer, multiple endocrine neoplasia syndrome, myelodysplastic syndromes, myeloid leukemia, nasal cavity and paranasal sinus cancer, nasopharyngeal carcinoma, neuroblastoma, non-Hodgkin lymphoma, non-small cell lung cancer, oral cancer, oropharyngeal cancer, osteosarcoma/malignant fibrous histiocytoma of bone, ovarian cancer, ovarian epithelial cancer, ovarian germ cell tumor, pancreatic cancer, pancreatic cancer islet cell, paranasal sinus and nasal cavity cancer, parathyroid cancer, penile cancer, pharyngeal cancer, pheochromocytoma, pineal astrocytoma, pineal germinoma, pituitary adenoma, pleuropulmonary blastoma, plasma cell neoplasia, primary central nervous system lymphoma, prostate cancer, rectal cancer, renal cell carcinoma, renal pelvis and ureter transitional cell cancer, retinoblastoma, rhabdomyo sarcoma, salivary gland cancer, sarcomas, skin cancers, skin carcinoma merkel cell, small intestine cancer, soft tissue sarcoma, squamous cell carcinoma, stomach cancer, T-cell lymphoma, throat cancer, thymoma, thymic carcinoma, thyroid cancer, trophoblastic tumor (gestational), cancers of unknown primary site, urethral cancer, uterine sarcoma, vaginal cancer, vulvar cancer, Waldenström macroglobulinemia, and Wilms tumor.

Non-limiting examples of genetic conditions include Achondroplasia, Alpha-1 Antitrypsin Deficiency, Antiphospholipid Syndrome, Autism, Autosomal Dominant Polycystic Kidney Disease, Breast cancer, Charcot-Marie-Tooth, Colon cancer, Cri du chat, Crohn's Disease, Cystic fibrosis, Dercum Disease, Down Syndrome, Duane Syndrome, Duchenne Muscular Dystrophy, Factor V Leiden Thrombophilia, Familial Hypercholesterolemia, Familial Mediterranean Fever, Fragile X Syndrome, Gaucher Disease, Hemochromatosis, Hemophilia, Holoprosencephaly, Huntington's disease, Klinefelter syndrome, Marfan syndrome, Myotonic Dystrophy, Neurofibromatosis, Noonan Syndrome, Osteogenesis imperfecta, Parkinson's disease, Phenylketonuria, Poland Anomaly, Porphyria, Progeria, Prostate Cancer, Retinitis Pigmentosa, Severe Combined Immunodeficiency (SCID), Sickle cell disease, Skin Cancer, Spinal Muscular Atrophy, Tay-Sachs, Thalassemia, Trimethylaminuria, Turner Syndrome, Velocardiofacial Syndrome, WAGR Syndrome, and Wilson Disease.

A system of the invention can be configured for use on any suitable device, for example, personal computer, tablet, or smartphone.

A system of the invention can provide a subject's relative risk of developing a health condition compared with a population based on the subject's health data. The risk can be categorized, for example, as none, low, moderate, or high. The risk can be reported as a percentage or a score. The risk can be, for example, about 0%, about 1%, about 2%, about 3%, about 4%, about 5%, about 10%, about 15%, about 20%, about 30%, about 40%, about 50%, about 60%, about 70%, about 80%, about 90%, or about 100%.

A system of the invention can provide health recommendations to a subject based on health data. Non-limiting examples of health recommendations include changes in lifestyle, physical activity, diet, medication, supplements, environmental factors, sun exposure, genetic testing, therapeutic intervention, and screening for health conditions.

### Statistical Functions Used in a System of the Invention.

To ascertain the accuracy of the methods, reliability assessments can be performed. One output that can be measured for test reliability is the Pearson's correlation coefficient (r). The Pearson's correlation coefficient can describe the linear relationship between two results and is between −1 and +1. The correlation coefficient for a sample, r, can be calculated using the following formula:

$$r = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}} ,$$

where n is the sample size; i=1, 2, . . . , n; X and Y are the variables, and X̅ and Y̅ are the means for the variables. The square of the Pearson's correlation coefficient, r², is known as the coefficient of determination and can be used to explain the fraction of variance in Y as a function of X in a simple linear regression.

The Pearson's correlation coefficient can also be used to describe effect size, which can be defined as the magnitude of the relationship between two groups. When the Pearson's correlation coefficient is used as a measure for effect size, the square of the result can estimate the amount of the variance within an experiment that is explained by the experimental model.

Reliability can be an indicator of the extent to which measurements are consistent over time and free from random error. Reliability can measure whether the test results are stable and internally consistent. The test-retest method is one measure that can be used for reliability. Test-retest reliability test can measure a change in a sample's results when the sample is administered the same test at two different times. If the results from the test given at two different times are similar, then the test can be considered reliable. The relationship between the two results can be described using the Pearson's correlation coefficient; the higher the value of the correlation coefficient, the higher the reliability of the test.

The value of the correlation coefficient for test-retest reliability can be, for example, about −1, about −0.95, about −0.9, about −0.85, about −0.8, about −0.75, about −0.7, about −0.65, about −0.6, about −0.55, about −0.5, about −0.45, about −0.4, about −0.35, about −0.3, about −0.25, about −0.2, about −0.15, about −0.1, about −0.05, about 0, about 0.05, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, or about 1.

Another test that can be used for measuring reliability of a test is the split-half reliability test. The split-half reliability test divides a test into two portions, provided that the two portions contain similar subject matter, and the test is administered to a sample. Then, scores of each half of the test from the sample are compared to each other. The correlation, or degree of similarity, between the scores from the two halves of the test can be described using the Pearson's correlation coefficient, wherein if the correlation is high, the test is reliable.

The value of the correlation coefficient for split-half reliability can be, for example, about −1, about −0.95, about −0.9, about −0.85, about −0.8, about −0.75, about −0.7, about −0.65, about −0.6, about −0.55, about −0.5, about −0.45, about −0.4, about −0.35, about −0.3, about −0.25, about −0.2, about −0.15, about −0.1, about −0.05, about 0, about 0.05, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, or about 1.

Validity is the extent to which a test measures what is intended. For a test to be valid, a test can demonstrate that the results of the test are contextually supported. Specifically, evidence regarding test validity can be presented via test content, response processes, internal structure, relation to other variables, and the consequences of testing.

A Hotelling's T-squared test is a multivariate test that can be employed by a system of the invention to determine the differences in the means of the results of different populations of subjects using the system. The test statistic (T²) for the T-squared test is calculated using the formula below:

$${T}^{2} = {( {\overline{x}}_{1} - {\overline{x}}_{2} )}^{′} {\{ {S}_{p} ( \frac{1}{{n}_{1}} + \frac{1}{{n}_{2}} ) \}}^{- 1} ( {\overline{x}}_{1} - {\overline{x}}_{2} ) ,$$

where x̅ is the sample mean, Sₚ is the pooled variance-covariance of the samples, and n is the sample size.

To compute the F-statistic, the following formula is used:

$$F = \frac{{n}_{1} + {n}_{2} - p - 1}{p ( {n}_{1} + {n}_{2} - 2 )} {T}^{2} ∼ {F}_{p , {n}_{1} + {n}_{2} - p - 1} ,$$

where p is the number of variables being analyzed, and the F-statistic is F-distributed with p and n₁+n₂−p degrees of freedom. An F-table can be used to determine the significance of the result at a specified a, or significance, level. If the observed F-statistic is larger than the F-statistic found in the table at the correct degrees of freedom, then the test is significant at the defined a level. The result can be significant at a p-value of less than 0.05 if, for example, the α level was defined as 0.05.

Analysis of variance (ANOVA) is a statistical test that can be used by a system of the invention to determine a statistically significant difference between the means of two or more groups of data. The F-statistic for ANOVA can be calculated as follows:

$$F = \frac{\frac{{{n}_{1} ( {\overline{x}}_{1} - \overline{x} )}^{2} + {{n}_{2} ( {\overline{x}}_{2} - \overline{x} )}^{2} + … + {{n}_{I} ( {\overline{x}}_{I} - \overline{x} )}^{2}}{I - 1}}{\frac{( {n}_{1} - 1 ) {s}_{1}^{2} + ( {n}_{2} - 1 ) {s}_{2}^{2} + … + ( {n}_{I} - 1 ) {s}_{I}^{2}}{N - I}} ,$$

where x̅ is the sample mean, n is the sample size, s is the standard deviation of the sample, I is the total number of groups, and N is the total sample size. An F-table is then used to determine the significance of the result at a specified a level. If the observed F-statistic is larger than the F-statistic found in the table at the specified degrees of freedom, then the test is significant at the defined a level. The result can be significant at a p-value of less than 0.05 if, for example, the α level was defined as 0.05.

The α level for the Hotelling's T-squared test or ANOVA can be set at, for example, about 0.5, about 0.45, about 0.4, about 0.35, about 0.3, about 0.25, about 0.2, about 0.15, about 0.1, about 0.05, about 0.04, about 0.03, about 0.02, about 0.01, about 0.009, about 0.008, about 0.007, about 0.006, about 0.005, about 0.004, about 0.003, about 0.002, or about 0.001.

An Area Under Curve (AUC) calculation of a risk model can be performed to determine the accuracy of health risk prediction.

Accuracy of age calculation methods of the invention can be assessed by, for example, monitoring disease incidence of the subject with that of a population. A subject can have a calculated age greater than the chronological age based on health data. The subject can be monitored to determine whether the subject develops health conditions or diseases at the same rate as individuals in a general population, wherein the individuals have a chronological age equivalent to the calculated age. For example, a system of the invention can suggest a calculated age of about 60-65 years for a subject. The subject can be assessed to determine whether the disease incidence in the subject, for example, for a health condition or disease of interest, is comparable with 60-65 year old individuals. A student's t-test can be performed to measure the accuracy of the calculated age.

To ascertain the accuracy of the methods, a student's t-test can be performed. A Student's t-test is a statistical test that can be employed by a system of the invention to determine the differences in the means of the results of two populations of subjects using the system. In the present system, the T-test can be used to measure the adherence to care protocols between the control and intervention groups. The test statistic (t) for the t-test of an independent, two sample study is calculated using the formula below:

$$t = \frac{{\overline{X}}_{1} - {\overline{X}}_{2}}{{s}_{{X}_{1} {X}_{2}} \cdot \sqrt{\frac{2}{n}}} ,$$

where x̅ is the sample mean, n is the sample size and

$${s}_{{X}_{1} {X}_{2}} = \sqrt{\frac{1}{2} ( {s}_{{X}_{1}}^{2} + {s}_{{X}_{2}}^{2} )} ,$$

where s is the standard deviation of group x₁ or x₂.

The degrees of freedom for such a test are 2n−2. Once the test statistic has been calculated, a p-value can be determined using a table of values following the Student's t-distribution. If the calculated p-value is below the value determined at the defined a level, and the corresponding degrees of freedom, then the result is considered significant. The result can be significant at a p-value of less than 0.05 if, for example, the α level was defined as 0.05.

The α level for the Student's t-test can be set at, for example, about 0.5, about 0.45, about 0.4, about 0.35, about 0.3, about 0.25, about 0.2, about 0.15, about 0.1, about 0.05, about 0.04, about 0.03, about 0.02, about 0.01, about 0.009, about 0.008, about 0.007, about 0.006, about 0.005, about 0.004, about 0.003, about 0.002, or about 0.001.

Any tool, interface, engine, application, program, service, command, or other executable item can be provided as a module encoded on a computer-readable medium in computer executable code. In some embodiments, the invention provides a computer-readable medium encoded therein computer-executable code that encodes a method for performing any action described herein, wherein the method comprises providing a system comprising any number of modules described herein, each module performing any function described herein to provide a result, such as an output, to a user.

### EXAMPLES

### Example 1

### Use of a System of the Invention in Determining the Age of a Subject with a Family History of Multiple Health Conditions

A healthy female subject uses a system of the invention to calculate her age based on family health history. The chronological age of the subject is 32 years. The subject uses an application of the system on her personal computer to input her health data, which includes a family history of bladder cancer, colon cancer, breast cancer, diabetes, heart disease, stroke, kidney cancer, lung cancer, ovarian cancer, pancreatic cancer, and skin cancer.

As shown in Table 2, the system calculates an age of the subject based on health data for each reported health condition and sums the individual ages to calculate an overall age of the subject.

TABLE 2
Calculated age of a subject with a family
history of multiple health conditions.

| | Age calculated by a system of the in- |
|---|---|
| Health Condition | vention based on family health history |
| Bladder cancer | 0.67656474 |
| Colon cancer | 0.89998224 |
| Breast cancer | 2.92629993 |
| Diabetes | 9.83374513 |
| Heart disease | 12.8005275 |
| Stroke | 6.22928254 |
| Kidney cancer | 0.35758744 |
| Lung cancer | 1.56897238 |
| Ovarian Cancer | 0.29116182 |
| Pancreatic Cancer | 0.36510363 |
| Skin Cancer | 0.52788634 |
| Overall Age of the Subject | 36.4771137 |
| years | 36 |
| months | 6 |

The individual ages associated with the health conditions, for example, as shown in Tables 2-6, can be determined using an age-risk curve as described herein. The individual ages can be weighted by the relative incidence of the health condition in a general population.

The system outputs a calculated age of 36 years based on the female subject's health data. The system also reports that the subject's risk of developing a health condition is comparable to a woman who is 4 years older than the 32-year-old female subject. Based on the calculated age and health risks, the system provides health recommendations tailored to the subject's health data, for example, frequent screening for the health conditions in her family health history, changes in diet, increase physical activity, and reduced sun exposure.

### Example 2

### Use of a System of the Invention in Determining the Age of a Subject with No Family History Health Conditions

A healthy female subject uses a system of the invention to calculate her age based on health data. The chronological age of the subject is 32 years. The subject does not have a family history of any health condition. The subject uses an application of the system on her smartphone to input her health data.

As shown in Table 3, the system calculates an age of the subject based on health data for each reported health condition and combines the individual ages to calculate an overall age of the subject.

TABLE 3
Calculated age of a subject with no
family history of health conditions.

| | Age calculated by a system of the in- |
|---|---|
| Health Condition | vention based on family health history |
| Bladder cancer | 0.488653474 |
| Colon cancer | 0.815634576 |
| Breast cancer | 2.638531498 |
| Diabetes | 7.331063134 |
| Heart disease | 11.08997409 |
| Stroke | 5.740232812 |
| Kidney cancer | 0.278590761 |
| Lung cancer | 0 |
| Ovarian Cancer | 0.250769969 |
| Pancreatic Cancer | 0.24229663 |
| Skin Cancer | 0.364548063 |
| Overall Age of the Subject | 29.24029501 |
| years | 29 |
| months | 3 |

The system outputs a calculated age of 29 years based on the subject's health data. The system also reports that the subject's risk of developing a health condition is comparable to a woman who is 3 years younger than the 32-year-old subject. However, the system notes the higher risks for heart disease and diabetes. Based on the calculated age and health risks, the system provides health recommendations tailored to the subject's health data, for example, continue to maintain a healthy lifestyle.

### Example 3

### Use of a System of the Invention in Determining the Age of a Subject with a Family History of Skin Cancer

A female subject uses a system of the invention to calculate her age based on health data. The chronological age of the subject is 32 years. The subject has a first-degree relative with melanoma skin cancer. The subject uses an application of the system at the doctor's office to input her health data.

As shown in Table 4, the system calculates an age of the subject based on health data for each reported health condition and combines the individual ages to calculate an overall age of the subject.

TABLE 4
Calculated age of a subject with a family history of skin cancer.

| | Age calculated by a system of the in- |
|---|---|
| Health Condition | vention based on family health history |
| Bladder cancer | 0.488653474 |
| Colon cancer | 0.815634576 |
| Breast cancer | 2.638531498 |
| Diabetes | 7.331063134 |
| Heart disease | 11.08997409 |
| Stroke | 5.740232812 |
| Kidney cancer | 0.278590761 |
| Lung cancer | 0 |
| Ovarian Cancer | 0.250769969 |
| Pancreatic Cancer | 0.24229663 |
| Skin Cancer | 0.527886341 |
| Overall Age of the Subject | 29.40363329 |
| years | 29 |
| months | 5 |

The system outputs a calculated age of 29 years based on the subject's family health history of skin cancer. The system also reports that the subject's risk of developing a health condition is comparable to a woman who is 3 years younger than the 32-year-old female subject. Based on the calculated age and family history of skin cancer, the system provides health recommendations customized to the subject, for example, avoid sunburns, use sunscreen, no tanning beds, and frequently screen for skin changes and moles.

### Example 4

### Use of a System of the Invention in Determining the Age of a Subject with a Family History of Heart Disease

A female subject uses a system of the invention to calculate her age based on a family health history of heart disease. The chronological age of the subject is 32 years. The subject has a first-degree relative with heart disease. The subject uses an application of the system on her tablet to input her health data.

As shown in Table 5, the system calculates an age of the subject based on health data for each reported health condition and combines the individual ages to calculate an overall age of the subject.

TABLE 5
Calculated age of a subject with a family history of heart disease.

| | Age calculated by a system of the in- |
|---|---|
| Health Condition | vention based on family health history |
| Bladder cancer | 0.488653474 |
| Colon cancer | 0.815634576 |
| Breast cancer | 2.638531498 |
| Diabetes | 7.331063134 |
| Heart disease | 12.80052747 |
| Stroke | 5.740232812 |
| Kidney cancer | 0.278590761 |
| Lung cancer | 0 |
| Ovarian Cancer | 0.250769969 |
| Pancreatic Cancer | 0.24229663 |
| Skin Cancer | 0.364548063 |
| Overall Age of the Subject | 30.95084839 |
| years | 30 |
| months | 11 |

The system outputs a calculated age of 31 years based on the subject's family health history of heart disease. The system also reports that the subject's risk of developing a health condition is comparable to a woman who is 1 year younger than the 32-year-old female subject.

### Example 5

### Use of a System of the Invention in Determining the Age of a Subject with a Family History of Heart Disease, Stroke, Lung, and Diabetes

A female subject uses a system of the invention to calculate her age based on a family health history of heart disease, stroke, lung cancer, and diabetes. The chronological age of the subject is 32 years. The subject uses an application of the system available on the internet to input her health data.

As shown in Table 5, the system calculates an age of the subject based on health data for each reported health condition and combines the individual ages to calculate an overall age of the subject.

TABLE 6
Calculated age of a subject with a family history of
heart disease, stroke, lung cancer, and diabetes.

| | Age calculated by a system of the in- |
|---|---|
| Health Condition | vention based on family health history |
| Bladder cancer | 0.488653474 |
| Colon cancer | 0.815634576 |
| Breast cancer | 2.638531498 |
| Diabetes | 9.833745131 |
| Heart disease | 12.80052747 |
| Stroke | 6.229282539 |
| Kidney cancer | 0.278590761 |
| Lung cancer | 1.56897238 |
| Ovarian Cancer | 0.250769969 |
| Pancreatic Cancer | 0.24229663 |
| Skin Cancer | 0.364548063 |
| Overall Age of the Subject | 35.51155249 |
| years | 35 |
| months | 6 |

The system outputs a calculated age of 35.5 years based on the subject's family health history of heart disease. The system also reports that the subject's risk of developing a health condition is comparable to a woman who is 3.5 years older than the 32-year-old female subject.

### Example 6

### Computer Architectures

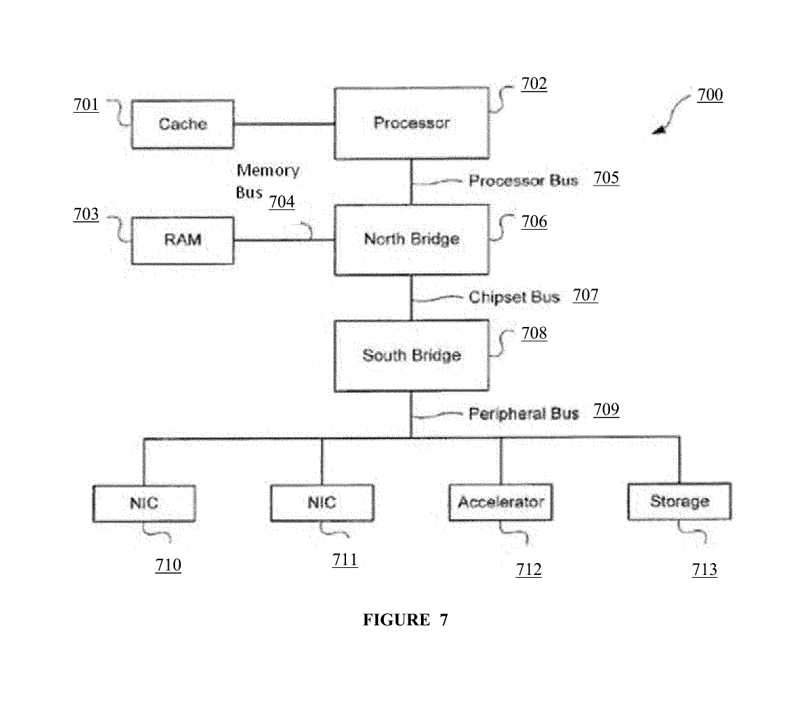

Various computer architectures are suitable for use with the invention. FIG. 7 is a block diagram illustrating a first example architecture of a computer system 700 that can be used in connection with example embodiments of the present invention. As depicted in FIG. 7, the example computer system can include a processor 702 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

### Data Acquisition, Processing and Storage.

As illustrated in FIG. 7, a high speed cache 701 can be connected to, or incorporated in, the processor 702 to provide a high speed memory for instructions or data that have been recently, or are frequently, used by processor 702. The processor 702 is connected to a north bridge 706 by a processor bus 705. The north bridge 706 is connected to random access memory (RAM) 703 by a memory bus 704 and manages access to the RAM 703 by the processor 702. The north bridge 706 is also connected to a south bridge 708 by a chipset bus 707. The south bridge 708 is, in turn, connected to a peripheral bus 709. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 709. In some architectures, the functionality of the north bridge can be incorporated into the processor instead of using a separate north bridge chip.

In some embodiments, system 700 can include an accelerator card 712 attached to the peripheral bus 709. The accelerator can include field programmable gate arrays (FPGAs) or other hardware for accelerating certain processing.

### Software Interface(s).

Software and data are stored in external storage 713 and can be loaded into RAM 703 and/or cache 701 for use by the processor. The system 700 includes an operating system for managing system resources; non-limiting examples of operating systems include: Linux, Windows™, MACOS™, BlackBerry OS™, iOS™, and other functionally-equivalent operating systems, as well as application software running on top of the operating system.

In this example, system 700 also includes network interface cards (NICs) 710 and 711 connected to the peripheral bus for providing network interfaces to external storage, such as Network Attached Storage (NAS) and other computer systems that can be used for distributed parallel processing.

### Computer Systems.

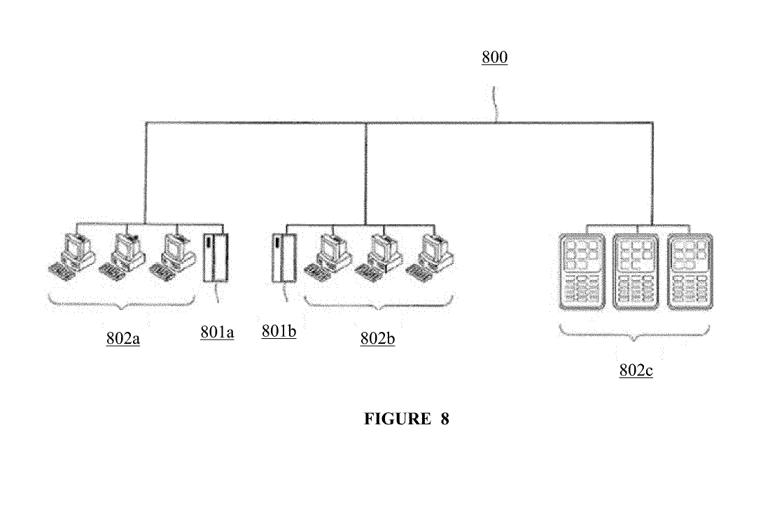

FIG. 8 is a diagram showing a network 800 with a plurality of computer systems 802a, and 802b, a plurality of cell phones and personal data assistants 802c, and Network Attached Storage (NAS) 801a, and 801b. In some embodiments, systems 802a, 802b, and 802c can manage data storage and optimize data access for data stored in Network Attached Storage (NAS) 801a and 802b. A mathematical model can be used for the data and be evaluated using distributed parallel processing across computer systems 802a, and 802b, and cell phone and personal data assistant systems 802c. Computer systems 802a, and 802b, and cell phone and personal data assistant systems 802c can also provide parallel processing for adaptive data restructuring of the data stored in Network Attached Storage (NAS) 801a and 801b. FIG. 8 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

### Virtual Systems.

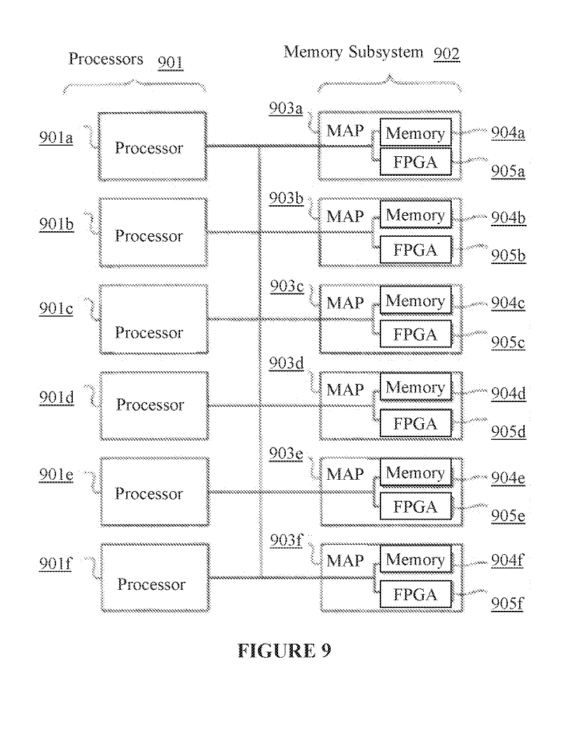

FIG. 9 is a block diagram of a multiprocessor computer system using a shared virtual address memory space. The system includes a plurality of processors 901a-f that can access a shared memory subsystem 902. The system incorporates a plurality of programmable hardware memory algorithm processors (MAPs) 903a-f in the memory subsystem 902. Each MAP 903a-f can comprise a memory 904a-f and one or more field programmable gate arrays (FPGAs) 905a-f. The MAP provides a configurable functional unit and particular algorithms or portions of algorithms can be provided to the FPGAs 905a-f for processing in close coordination with a respective processor. In this example, each MAP is globally accessible by all of the processors for these purposes. In one configuration, each MAP can use Direct Memory Access (DMA) to access an associated memory 904a-f, allowing it to execute tasks independently of, and asynchronously from, the respective microprocessor 901a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

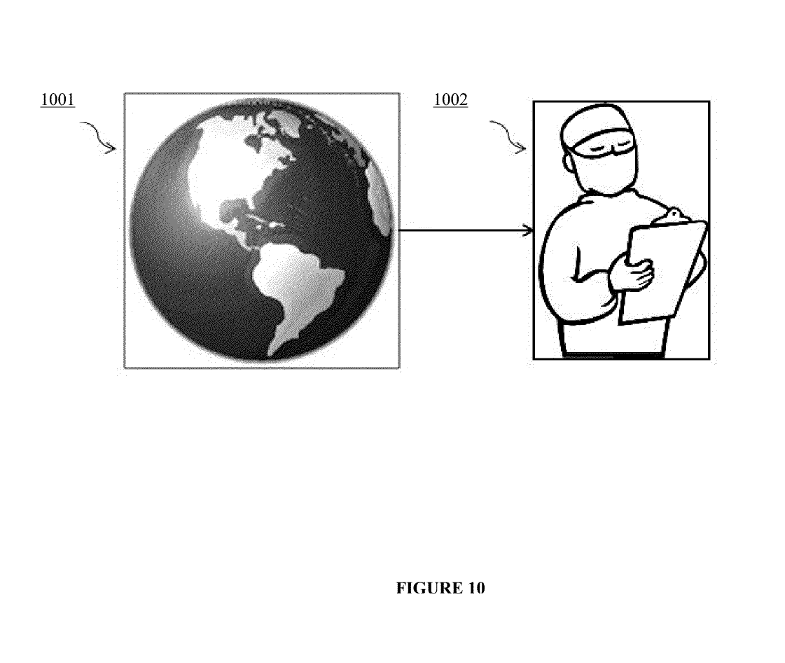

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 9, system on chips (SOCs), application specific integrated circuits (ASICs), or other processing and logic elements. For example, the Set Processor and Optimizer can be implemented with hardware acceleration through the use of a hardware accelerator card, such as accelerator card 1012 illustrated in FIG. 10.

Any embodiment of the invention described herein can be, for example, produced and transmitted by a user within the same geographical location. A product of the invention can be, for example, produced and/or transmitted from a geographic location in one country and a user of the invention can be present in a different country. In some embodiments, the data accessed by a system of the invention is a computer program product that can be transmitted from one of a plurality of geographic locations 1001 to a user 1002 (FIG. 10). Data generated by a computer program product of the invention can be transmitted back and forth among a plurality of geographic locations, for example, by a network, a secure network, an insecure network, an internet, or an intranet. In some embodiments, an ontological hierarchy provided by the invention is encoded on a physical and tangible product.

### Example 6

### On-Line Portal

An on-line portal of the invention can include any of the following non-limiting examples of modules.

### Genetic Age Module.

Members of the on-line portal can use the app for capturing, crowdsourcing (within family), and storing family health information that can be used as a quick reference at doctor's appointments and for other direct health care purposes, including emergency situations. Additionally, members can improve health by using the challenge features to remain accountable to their goals. The genetic age component allows members to see how improving health can reduce genetic age on a real-time basis. Ongoing, personalized health risk modules dig deeper into an individual member's behavior and lifestyle and how that can impact different health conditions.

### Health Risk Models.

Non-limiting examples of features include: a series of assessment questions related to the members' habits and health conditions; a final deliverable of a relative risk rating to the member to show potential risks for developing the condition assessed; and additional links to further information on the particular health condition, including original content created for the online portal. Through a series of assessment questions developed, the member can determine potential genetic risk for developing certain conditions. Giving members a way to identify risks before issues arise and providing guidance on prevention and management related to specific risks allows users to take control of their own health and understand risk factors in advance of illness.

### Connecting Health Conditions to Condition Information.

Within the family health tree, this feature allows users to view relevant information about a particular family member's condition by selecting the condition icon. Once an icon is clicked, the coordinating information opens in a new screen. By being able to link directly to the health content from the family health tree, users can sift through content to find the information that is relevant to their personal information.

Ability to Share Family Health Tree with Non-Family Members.

This feature allows members to share personal health profiles (within the family health tree) with care provides (e.g., babysitters, school nurses, doctors, etc), to access health information for a specific family member. Care providers can view and add annotations to information in the personal health profile of that individual. The member can dictate which information is accessible by the care provider.

Giving members an additional feature of allowing access to specific health information and directives to caregivers can reduce the potential for human error in communication and is easy to use due to the availability of the information in the family health tree. Members can use this feature to keep caregivers up-to-date on medications, allergies, conditions, and health care directives by just adjusting their privacy settings.

### Health Insurance Pre-Authorization.

This feature provides insurance pre-authorization for genetic testing and other preventative services based on their family health risks and personal health risk assessments. The portal provider can store or call for Medical Policy and Benefits Policy for each integrated health payer and seamlessly integrate with existing Pre-Auth software by generating and submitting an electronic pre-authorization request to a member's insurance company if the portal determines that the member qualifies for services according to Medical Policy.

### Emergency Access and Alerts.

An emergency access page and a unique code for each member for emergencies allow emergency responders or appropriate people access to a person's medical records. Once the record has been accessed through the emergency access code/portal, a notification is sent to the user's designated emergency contacts in their PHP. Options include Emergency Access for EMS and Healthcare providers with automatic notification triggers to alert emergency contacts listed in the portal as to who/where the records were accessed; and ICE “in case of emergency” access to limited most critical health information in a crisis for bystanders. This feature includes a specific emergency access button on the portal website and on the mobile app. This feature also includes having medical ID jewelry or a pocket card with a unique portal member ID number for information access.

Privacy levels for this access can be set at: 1) total record access; 2) only basic critical medical records; or 3) no records released but emergency contacts notified and able to contact the emergency department or responders to grant access. This feature helps EMS workers get access to critical information about a portal member. Through the portal platform, when a profile is accessed through the “emergency responder” login, an alert is triggered to the member's emergency contacts, notifying the contacts that something has happened to the member, and the location of any health care institution providing care to the member. This feature removes the barrier of identification and notification of family members in an emergency for EMS workers and providers.

### Environmental & Weather Impacts on Health.

This feature provides environmental information and weather details that can contribute to health issues and conditions for a member, a member's family, a neighborhood, city, or region. Using historical data in combination with a member's health information and date of onset, the portal can identify and analyze patterns. Storing this information provides a large database of historical environmental trends to be used in predictive models. This feature also helps understand past patterns that can help forecast future health incidents and outbreaks, and can alert members in advance. The feature can also identify environmental impact on community health by aggregating data on conditions in a geographic region.

### Ways to Save Money on Health.

This feature helps members understand ways to save money on health and on treatments, medication, and services for health conditions. If members choose to store details of their health insurance, then the portal can integrate with the health plan benefits and provider directory to alert the member to in-network providers, formulary drugs, and benefits information to help the member make more cost-conscious, medically-appropriate decisions about treatment and prophylaxis. The portal can integrate with retail pharmacies to locate prices, specials, and coupons, and even connect with rewards programs to identify deals on relevant health care services, medications, and over the counter health and wellness items.

### Family Health Tree Nodes.

This feature allows a member to add new family members directly from the family health tree without having to open a node's PHP. This feature also allows for a quick way to edit and delete profiles.

### Dynamic Question Widget.

The Dynamic Question Widget allows for a survey approach to asking questions of a member, and for customizing questions for healthcare customers. The feature creates maximum flexibility for capturing important health information and for asking more detailed questions based on previous answers from the member or the member's family about their health. The platform can create scenarios based on the needs of healthcare customers. This feature can also use machine learning to identify risks or conditions within a family not identified by other family members. This feature can connect members with clinical research trials and assist with enrollment in trials.

Birth Parent Family Health History Adoption Record.

The platform allows family health history from the birth father and mother of an adopted child to be shared with the adopted family/child anonymously. This information is integrated with adoption agencies and egg and sperm donor banks.

### Symptom Tracker Integrations.

The platform integrates with symptom and meal trackers, and uses machine learning to plot the data along with family history and environmental factors to create visuals (charts, graphs, maps, etc.) around when/where symptoms occur and common causes of symptoms. By collecting health data from multiple sources and combining data into easy-to-interpret visuals, members and health professionals can more easily identify patterns that lead to diagnosis.

### Health Risk Financial Modeling.

Based on a member's Family Health History and published clinical studies on end-of-life disease costs, the portal helps members understand the financial impact and potential costs based on risk profile. This feature provides a starting point for financial planning and making more informed decisions on retirement savings and levels of insurance needed. This feature can also be used as an incentive to focus on prevention and making changes to lower health risks. This modeling helps provide more tailored financial, life insurance, and long-term care planning to prepare better for potential financial hardships in retirement due to the costs of chronic health conditions.

### Location-Based Health Advice.

Based on a member's GPS location, the module provides location-based, personalized advice such as allergen alerts, infection risks, and health and wellness information such as health fairs, vaccination opportunities, nearby farmers markets, and health clubs.

### Pre-Conception Risk Assessment.

This module is a risk assessment that combines family health history from both parents to predict risks associated for a potential child. Features include: a series of assessment questions related to the member's habits and health conditions; a final deliverable of a relative risk rating to the member to indicate what potential risk that the member's children can have for certain genetic conditions; and additional links to further information on the particular health condition, including original content created for the portal. This assessment helps couples to understand how combined health histories can impact their children, and what preventative measures could be taken pre-conception.

### Curriculum/Teaching Lessons.

The platform provides curriculum resources produced by subject matter experts. These materials can be used to explain the biological basis of disease, mechanism of drug and treatment action, and genetic topics. The portal can tailor this curriculum to provide long term course work for classrooms such as home schooled students. The availability of a reputable and reliable source of scientific content can lead to insights for improving health outcomes, reducing costs, and improving communication with health care providers. The feature can also arm school children with real world application and experience in understanding human biology, health, and medicine.

### Telehealth In-App Video Conferencing.

Within the Family Health Tree, members have the option to have a video call with a healthcare professional who specializes in a specific condition. The health professionals can answer user questions and provide personalized feedback. The user can update privacy settings to give the health professional access to all necessary documents and information so that feedback is relevant and targeted directly to the user's unique needs. The user can access the video call from directly within their Family Health Tree by selecting the option from a menu that populates within their Personal Health Profile once they add a condition.

### Appointment Follow-Up or Prep.

This feature allows users to input the time and date of appointments, and trigger a workflow on the backend for portal health care professionals to set up an appointment follow-up call or email. Within 24 hours of the user's appointment, a portal health professional can field any questions or provide feedback regarding what transpired at the appointment. The user can also request a call 24 hours prior to an appointment to get feedback on questions to ask the physician or symptoms to follow-up on.

### Genetic Testing Integration.

By combining the portal users' personal health with the users' genomic information, the portal can access a massive amount of health information for use by healthcare systems, researchers, and organizations to assess health trends both historical and predictive. Creating predictive health risk models can provide creative a prophylactic health care plan for users and the population at-large to reduce the stress on existing healthcare systems.

### Example 7

### Use of a System of the Invention to Determine a Health Risk of a Subject

A subject uses a system of the invention to determine personalized health risk based on for example, the subject's family health history, lifestyle risk factors, exercise habits, and age.

By querying a population database of the invention, a disease-specific logistic regression risk model can be generated. The database can comprise health information of a plurality of members of a population. The disease-specific logistic regression risk model can be generated using several phenotypic variables, for example, family health history including information on number of affected first degree relatives, life style risk factors including exercise habits and frequency, and other basic information including age.

In the next step, the database is queried using the subject's health information to obtain the subject's values for each variable of interest, for example family health history, exercise habits, and age.

The subject's values are then applied to the disease-specific logistic regression risk model of the system to generate and output the subject's health risk, for example, the subject's risk of developing a health condition.

### Example 8

### Use of a System of the Invention to Determine a Calculated Age of a Subject

A subject uses a system of the invention to determine a calculated age of the subject based on health data.

Using the system's database, a subject's family health history information is extracted. The database can comprise health information of a plurality of subjects of a population.

The subject's risk of developing or being affected by a health condition is adjusted based on the extracted family health history information for each health condition. For example, if the subject has a family history of a health condition, the risk can be adjusted to be higher that the population average risk for that health condition. The degree of adjustment can be determined by, for example, how common the condition is in a population and the relative risk associated with a family history of the health condition.

Using population data, an age-risk curve can be generated for a health condition. The subject's adjusted risk for a health condition can be plotted on the age-risk curve to determine an equivalent or health condition-specific age of the subject for the health condition.

Each equivalent age corresponding to a health condition can be weighted based on the disease incidence in a general population and summed to obtain an overall calculated age of the subject.

### EMBODIMENTS

### Embodiment 1

A method comprising: a) receiving an electronic communication containing health information encoded in a computer-readable code for each of a subject and a blood relative of the subject; b) extracting from the computer-readable code the encoded health information of the subject and transferring the extracted encoded health information of the subject to a first memory sector; c) extracting from the computer-readable code the encoded health information of the blood relative of the subject and transferring the extracted encoded health information of the blood relative of the subject to a second memory sector; d) creating a health profile of the subject by copying content of the first memory sector into the health profile of the subject; e) creating a health profile of the blood relative of the subject by copying content of the second memory sector into the health profile of the blood relative of the subject; f) displaying on a visual display the health profile of the subject and the health profile of the blood relative of the subject in a spatial relationship that suggests a genealogical relationship between the subject and the blood relative of the subject; g) generating a query based on the extracted encoded health information of the subject and the extracted encoded health information of the blood relative of the subject; h) searching a database based on the query, wherein the database stores entries, each entry encoded with health risks of a member of a sample population, to identify a health risk within the sample population common to a health risk present in the extracted encoded health information of the subject; i) searching the database based on the query, wherein the database stores entries, each entry encoded with health risks of a member of the sample population, to identify a health risk within the sample population common to a health risk present in the extracted encoded health information of the blood relative of the subject; f) computing a relative level of risk for the subject versus the sample population based on a comparison; and g) electronically annotating the health profile of the subject with the computed relative level of risk for the subject versus the sample population.

### Embodiment 2

The method of Embodiment 1, wherein the health information of the subject comprises genetic data of the subject.

### Embodiment 3

The method of any one of Embodiments 1-2, further comprising providing a health recommendation to the subject based on the computed relative level of risk.

### Embodiment 4

A method comprising: a) creating on a physical memory a first data node and a second data node; b) creating on the physical memory a first subnode associated with the first data node; c) creating on the physical memory a second subnode associated with the second data node; d) populating the first data node with a computer-readable code that encodes an image of a person; e) populating the second data node with a computer-readable code that encodes an image of a relative of the person; f) populating the first subnode with health risk data of the person; g) populating the second subnode with health episode data of the relative of the person; h) transmitting from the first data node to a visual display module an electronic signal that conveys the computer-readable code that encodes the image of the person; i) transmitting from the second data node to the visual display module an electronic signal that conveys the computer-readable code that encodes the image of the relative of the person; j) processing by the visual display module the computer-readable code that encodes the image of the person into an image of the person; k) processing by the visual display module the computer-readable code that encodes the image of the relative of the person into an image of the relative of the person; l) displaying on a visual display the image of the person and the image of the relative of the person in a spatial relationship that suggests a genealogical relationship between the person and the relative of the person; m) transmitting from the first subnode to a health icon module an electronic signal that conveys the health risk data of the person; n) transmitting from the second subnode to the health icon module an electronic signal that conveys the health episode data of the relative of the person; o) processing by the health icon module the health risk data of the person to produce an icon that suggests a health risk of the person; p) processing by the health icon module the health episode data of the relative of the person to produce an icon that identifies a health episode of the relative of the person; q) displaying on the visual display module in proximity to the image of the person the icon that suggests the health risk of the person; and r) displaying on the visual display module in proximity to the image of the relative of the person the icon that identifies the health episode of the relative of the person.

### Embodiment 5

The method of Embodiment 4, wherein the visual display module displays images of more than one relative of the person in a spatial relationship that suggests a genealogical relationship between the person and each of the relatives of the person.

### Embodiment 6

The method of any one of Embodiments 4-5, further comprising displaying on the visual display in proximity to the image of the person a health recommendation for the person based on the health risk of the person.

### Embodiment 7

The method of any one of Embodiments 4-6, further comprising displaying on the visual display in proximity to the image of the person a health recommendation for the person based on the health episode of the relative of the person.

### Embodiment 8

A method comprising: a) receiving an electronic communication comprising health information of a subject encoded in a computer-readable code; b) extracting from the computer-readable code the encoded health information of the subject and transferring the extracted encoded health information of the subject to a memory sector; c) creating a health profile of the subject by copying content of the memory sector into the health profile; d) identifying a plurality of health risk factors of the subject based on the health profile of the subject; e) generating a query based on the identified health risk factors of the subject; f) searching a database based on the query, wherein the database stores entries of a sample population, wherein each entry is encoded with an age and a health risk of a member of the sample population, to identify an age adjustment factor that corresponds to one of the identified health risk factors of the subject; g) calculating an age of the subject based on a plurality of age adjustment factors; and h) electronically annotating the health profile of the subject with the calculated age of the subject, wherein the calculated age corresponds to the subject's state of health based on the extracted health data of the subject.

### Embodiment 9

The method of Embodiment 8, wherein the age adjustment factor is weighted based on a prevalence of a health condition in a population.

### Embodiment 10

The method of any one of Embodiments 8-9, wherein the electronic communication further comprises an image of the subject encoded in a computer-readable code, wherein the method further comprises processing the computer-readable code that encodes the image of the subject into an image of the subject, and displaying on a visual display the image of the subject and the calculated age of the subject in proximity to the image of the subject.

### Embodiment 11

The method of any one of Embodiments 8-10, wherein the health information about the subject comprises data related to an environmental factor associated with a health condition.

### Embodiment 12

The method of any one of Embodiments 8-11, wherein the health information about the subject comprises genetic data.

### Embodiment 13

The method of Embodiment 12, wherein each entry in the database is further encoded with the genetic data of a member of the population.

### Embodiment 14

The method of any one of Embodiments 8-13, further comprising outputting an arithmetic difference between the chronological age of the subject and the calculated age of the subject.

### Embodiment 15

The method of Embodiment 14, further comprising electronically annotating the health profile of the subject with the arithmetic difference between the chronological age of the subject and the calculated age of the subject.

### Embodiment 16

The method of any one of Embodiments 8-15, further comprising determining a risk of developing a health condition by the subject based on the identified health risks of the subject.

### Embodiment 17

The method of Embodiments 16, further comprising electronically annotating the health profile of the subject with the risk of developing the health condition by the subject.

### Embodiment 18

The method of any one of Embodiments 8-17, further comprising providing a health recommendation to the subject based on the calculated age of the subject.

### Embodiment 19

The method of any one of Embodiments 8-18, wherein the health information of the subject comprises information about a health condition of a blood relative of the subject.

### Embodiment 20

The method of Embodiment 19, wherein one of the identified health risks of the subject is further based on the health condition of the blood relative of the subject.

What is claimed is:

1. A method comprising:
a) receiving an electronic communication containing health information encoded in a computer-readable code for each of a subject and a blood relative of the subject;
b) extracting from the computer-readable code the encoded health information of the subject and transferring the extracted encoded health information of the subject to a first memory sector;
c) extracting from the computer-readable code the encoded health information of the blood relative of the subject and transferring the extracted encoded health information of the blood relative of the subject to a second memory sector;
d) creating a health profile of the subject by copying content of the first memory sector into the health profile of the subject;
e) creating a health profile of the blood relative of the subject by copying content of the second memory sector into the health profile of the blood relative of the subject;
f) displaying on a visual display the health profile of the subject and the health profile of the blood relative of the subject in a spatial relationship that suggests a genealogical relationship between the subject and the blood relative of the subject;
g) generating a query based on the extracted encoded health information of the subject and the extracted encoded health information of the blood relative of the subject;
h) searching a database based on the query, wherein the database stores entries, each entry encoded with health risks of a member of a sample population, to identify a health risk within the sample population common to a health risk present in the extracted encoded health information of the subject;
i) searching the database based on the query, wherein the database stores entries, each entry encoded with health risks of a member of the sample population, to identify a health risk within the sample population common to a health risk present in the extracted encoded health information of the blood relative of the subject;
f) computing a relative level of risk for the subject versus the sample population based on a comparison; and
g) electronically annotating the health profile of the subject with the computed relative level of risk for the subject versus the sample population.

2. The method of claim 1, wherein the health information of the subject comprises genetic data of the subject.

3. The method of claim 1, further comprising providing a health recommendation to the subject based on the computed relative level of risk.

4. A method comprising:
a) creating on a physical memory a first data node and a second data node;
b) creating on the physical memory a first subnode associated with the first data node;
c) creating on the physical memory a second subnode associated with the second data node;
d) populating the first data node with a computer-readable code that encodes an image of a person;
e) populating the second data node with a computer-readable code that encodes an image of a relative of the person;
f) populating the first subnode with health risk data of the person;
g) populating the second subnode with health episode data of the relative of the person;
h) transmitting from the first data node to a visual display module an electronic signal that conveys the computer-readable code that encodes the image of the person;
i) transmitting from the second data node to the visual display module an electronic signal that conveys the computer-readable code that encodes the image of the relative of the person;
j) processing by the visual display module the computer-readable code that encodes the image of the person into an image of the person;
k) processing by the visual display module the computer-readable code that encodes the image of the relative of the person into an image of the relative of the person;
l) displaying on a visual display the image of the person and the image of the relative of the person in a spatial relationship that suggests a genealogical relationship between the person and the relative of the person;
m) transmitting from the first subnode to a health icon module an electronic signal that conveys the health risk data of the person;
n) transmitting from the second subnode to the health icon module an electronic signal that conveys the health episode data of the relative of the person;
o) processing by the health icon module the health risk data of the person to produce an icon that suggests a health risk of the person;
p) processing by the health icon module the health episode data of the relative of the person to produce an icon that identifies a health episode of the relative of the person;
q) displaying on the visual display module in proximity to the image of the person the icon that suggests the health risk of the person; and
r) displaying on the visual display module in proximity to the image of the relative of the person the icon that identifies the health episode of the relative of the person.

5. The method of claim 4, wherein the visual display module displays images of more than one relative of the person in a spatial relationship that suggests a genealogical relationship between the person and each of the relatives of the person.

6. The method of claim 4, further comprising displaying on the visual display in proximity to the image of the person a health recommendation for the person based on the health risk of the person.

7. The method of claim 4, further comprising displaying on the visual display in proximity to the image of the person a health recommendation for the person based on the health episode of the relative of the person.

8. A method comprising:
a) receiving an electronic communication comprising health information of a subject encoded in a computer-readable code;
b) extracting from the computer-readable code the encoded health information of the subject and transferring the extracted encoded health information of the subject to a memory sector;
c) creating a health profile of the subject by copying content of the memory sector into the health profile;
d) identifying a plurality of health risk factors of the subject based on the health profile of the subject;
e) generating a query based on the identified health risk factors of the subject;
f) searching a database based on the query, wherein the database stores entries of a sample population, wherein each entry is encoded with an age and a health risk of a member of the sample population, to identify an age adjustment factor that corresponds to one of the identified health risk factors of the subject;
g) calculating an age of the subject based on a plurality of age adjustment factors; and
h) electronically annotating the health profile of the subject with the calculated age of the subject, wherein the calculated age corresponds to the subject's state of health based on the extracted health data of the subject.

9. The method of claim 8, wherein the age adjustment factor is weighted based on a prevalence of a health condition in a population.

10. The method of claim 8, wherein the electronic communication further comprises an image of the subject encoded in a computer-readable code, wherein the method further comprises processing the computer-readable code that encodes the image of the subject into an image of the subject, and displaying on a visual display the image of the subject and the calculated age of the subject in proximity to the image of the subject.

11. The method of claim 8, wherein the health information about the subject comprises data related to an environmental factor associated with a health condition.

12. The method of claim 8, wherein the health information about the subject comprises genetic data.

13. The method of claim 12, wherein each entry in the database is further encoded with the genetic data of a member of the population.

14. The method of claim 8, further comprising outputting an arithmetic difference between the chronological age of the subject and the calculated age of the subject.

15. The method of claim 14, further comprising electronically annotating the health profile of the subject with the arithmetic difference between the chronological age of the subject and the calculated age of the subject.

16. The method of claim 8, further comprising determining a risk of developing a health condition by the subject based on the identified health risk of the subject.

17. The method of claim 16, further comprising electronically annotating the health profile of the subject with the risk of developing the health condition by the subject.

18. The method of claim 8, further comprising providing a health recommendation to the subject based on the calculated age of the subject.

19. The method of claim 8, wherein the health information of the subject comprises information about a health condition of a blood relative of the subject.

20. The method of claim 19, wherein one of the identified health risks of the subject is further based on the health condition of the blood relative of the subject.
